(19) United States
(12) Patent Application Publication
(10) Pub. No.: US 2020/0327501 A1
(43) Pub. Date: Oct. 15, 2020

(54) Transaction Management System and Managing Method Thereof

(71) Applicant: David & Raymond Patent Firm, Monterey Park, CA (US)

(72) Inventors: Raymond Y. CHAN, Monterey Park, CA (US); Rihui CHEN, Shenzhen (CN); Xueguang DONG, Shenzhen (CN); Tiaowan LIU, Shenzhen (CN); Wei DU, Shenzhen (CN); Xiaoxiao DUAN, Shenzhen (CN)

(21) Appl. No.: 16/796,912

(22) Filed: Feb. 20, 2020

(30) Foreign Application Priority Data
Feb. 20, 2019 (CN) 2019101261177

(51) Int. Cl. G06Q 10/10; G06Q 10/06; G06Q 50/18; G06F 16/23

(52) U.S. Cl. CPC G06Q 10/103; G06Q 10/06313; G06F 16/2379; G06Q 10/1097; G06Q 10/063114; G06Q 50/184

(57) ABSTRACT

A transaction management system includes an analysis module, analyzing a character requirement and a processing deadline of at least one transaction to be assigned, wherein the analysis module analyzes a working state of at least one character to obtain an available time, and an assignment module, communicatively connected with the analysis module to assign the character having available time before the processing deadline and meeting the character requirement to be at least one executor of the transaction.

### CROSS REFERENCE OF RELATED APPLICATION

This is a non-provisional application that claims the benefit of priority under 35 U.S.C. § 119 to a Chinese application, Chinese application number 2019101261177, filed Feb. 20, 2019.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to intellectual property, and more particularly to a transaction management system and managing method thereof.

### Description of Related Arts

The management software to manage the various working tasks helps to improve working efficiency. One task or transaction needs to be handled by specific person, and generally needs to be completed within a certain period of time. Managers assign transactions to specific workers to do. However, if the manager use traditional ways, such as mail, chat software, face-to-face conversation, etc., the current working state of each person during the distribution is unknown, and the accurately working schedule of each person is unknown. So it is possible that the manager assign transactions to inappropriate workers, which can easily delay transaction processing. It is easy to cause loss when the transaction is not finished in time.

In addition, the time required to process the transaction is different because of different experiences and differences in capabilities of workers. Therefore, during assigning transactions, manager needs to assign tasks according to the processing deadline of the transaction combined with the time needed by different people. Before assigning transactions, it is not easy to master the accurate work schedule of each worker. Maybe possible to use cellphone software. However, the assignment of a transaction is also based on the processing difficulty of the transaction, and is required to be handled by a sufficient group of people to do the transaction properly. Therefore, there are many factors to consider when assigning a transaction in order to get a suitable assignment.

Especially in the field of intellectual property, it is very important to consider the processing deadline of the case. Deferring the application for intellectual property rights will have an unpredictable impact on the rights of the inventor. The various processes of intellectual property firm needs to cooperate together in order to effectively guarantee the time of completion of the case. It is important to know the working state of the participants in each task, such as drafting engineers and drawing engineers. If the case is assigned to an engineer who does not have the proper time to do it, it is highly likely that the case will be postponed. Moreover, if it needs several engineers to process one transaction, and the cooperation has troubles, the completion of the transaction will be delayed. Therefore, it is important to assign a case to the right person.

### SUMMARY OF THE PRESENT INVENTION

The invention is advantageous in that it provides a transaction management system and managing method thereof, wherein transaction management system manage the transaction and the character for assigning the appropriate character for processing.

Another advantage of the invention is to provide a transaction management system and managing method thereof, wherein the transaction management system analyzes the demand of transaction waiting to be assigned to specify the appropriate character for processing.

Another advantage of the invention is to provide a transaction management system and managing method thereof, wherein the transaction management system divides the level of the characters to manage each character.

Another advantage of the invention is to provide a transaction management system and managing method thereof, wherein the transaction management system classifies levels according to the processing capabilities of each character.

Another advantage of the invention is to provide a transaction management system and managing method thereof, wherein the transaction management system classifies types of transactions to assign the character according to different type of the transactions.

Another advantage of the invention is to provide a transaction management system and managing method thereof, wherein the transaction management system assigns transaction to different levels of characters according to different processing stages of the transaction.

Another advantage of the invention is to provide a transaction management system and managing method thereof, wherein the transaction management system monitors the progress of the transaction to control the transaction to be finished in time.

Another advantage of the invention is to provide a transaction management system and managing method thereof, wherein the transaction management system assigns the transaction to character with the available time according to the processing deadline of the transaction.

Another advantage of the invention is to provide a transaction management system and managing method thereof, wherein the transaction management system monitors the characters to determine the current working state of the characters.

Another advantage of the invention is to provide a transaction management system and managing method thereof, wherein the transaction management system analyzes the level demand of transaction according to the type of the transaction to assign the transaction to character that meets the requirement.

Another advantage of the invention is to provide a transaction management system and managing method thereof, wherein the transaction management system divides the processing stage that the transaction need to undergo and analyzes the level demand of each of the processing stage to assign character for each of the processing stage.

Additional advantages and features of the invention will become apparent from the description which follows, and may be realized by means of the instrumentalities and combinations particular point out in the appended claims.

According to the present invention, the foregoing and other objects and advantages are attained by a transaction management system comprising:

an analysis module analyzing a character requirement and a processing deadline, wherein the analysis module analyzes working state of at least one character to obtain an available time of the character; and

an assignment module communicatively coupled with the analysis module to assign the character with the available time before the processing deadline and met the character requirement to be at least one executor for the transaction.

According to an embodiment of the present invention, the transaction management system further comprises a transaction module, wherein the transaction module acquires information of the transaction to create the transaction and record the state of the transaction, wherein the analysis module is communicatively coupled with the transaction module to acquire information of the transaction from the transaction module.

According to an embodiment of the present invention, the transaction module comprises:

a transaction state module, wherein the transaction state module creates the transaction, wherein the transaction state module records information of the transaction, wherein the transaction state module records content that the transaction needed to process; and

a type module communicatively coupled with the transaction state module to obtain information of the transaction and the transaction, wherein the type module determines a type of the transaction based on content that the transaction needed to process.

According to an embodiment of the present invention, the transaction module comprises:

a processing deadline setting module communicatively coupled with the transaction state module to obtain information of the transaction and the transaction, wherein the processing deadline setting module sets a processing deadline for the transaction; and

a processing stage dividing module communicatively coupled with the transaction state module to obtain information of the transaction and the transaction, wherein the processing stage dividing module partitions at least one processing stage of the transaction according to content that the transaction needed to process.

According to an embodiment of the present invention, the processing stage dividing module is communicatively coupled with the type module to obtain the type to which the transaction belongs, wherein the processing stage dividing module partitions processing stage of the transaction according to the type of the transaction.

According to an embodiment of the present invention, the processing deadline setting module is communicatively coupled with the processing stage dividing module to obtain the processing stage in which the transaction is partitioned, wherein the processing deadline setting module is set the processing deadline for each of the processing stages of the transaction.

According to an embodiment of the present invention, the transaction management system further comprises a character module, wherein the character module manages the characters, wherein the analysis module is communicatively coupled with the character module to obtain the character for analysis.

According to an embodiment of the present invention, the character module comprises:

a character state module, wherein the character state module creates the character, and records information of the character; and

a level module communicatively coupled with the character state module to obtain the character, wherein the level module gives a level to the character.

According to an embodiment of the present invention, the character module further comprises a processing time calculating module communicatively coupled with the character state module, wherein the character state module records the historical data of the transaction processed by the character, wherein the processing time calculating module calculates an average processing time of the character to process the transaction based on historical data.

According to an embodiment of the present invention, the analysis module comprises a transaction analysis module and a character analysis module, wherein the transaction analysis module is communicatively coupled with the transaction module to analyze the transaction, and the character analysis module is communicatively coupled with the character module to analyze the character.

According to an embodiment of the present invention, the transaction analysis module comprises:

a type analysis module communicatively coupled with the transaction module to obtain the type of the transaction, wherein the type analysis module analyzes character requirements of the transaction based on the type of the transaction; and

a processing stage analysis module communicatively coupled with the transaction module to obtain the processing stage of the transaction, wherein the processing stage analyzes character requirements of the processing stage of the character.

According to an embodiment of the present invention, the type analysis module further analyzes a processing difficulty of the transaction according to the type of the transaction, generates a level requirement of the transaction, and the processing stage analysis module further generates the level requirements of each of the processing stages according to the difficulty of each of the processing stage of the transaction.

According to an embodiment of the present invention, the character analysis module comprises:

a working state analysis module communicatively coupled with the character module to obtain the transaction that the character has been assigned, and analyze the working state of the character; and

an available time analysis module communicatively coupled with the working state analysis module to obtain the working state of the character, wherein the available time analysis module is communicatively coupled with the character module to acquires the average processing time of the transaction of the character processed from the processing time calculating module, wherein the available time analysis module calculates the available time of the character according to the working state and the average processing time of the character.

According to an embodiment of the present invention, the analysis module comprises a requirement matching module communicably and respectively connected with the transaction analysis module and the character analysis module to acquire character requirement of the transaction and the available time of the character respectively, wherein the requirement matching module matches to obtain the character available for assignment to the transaction.

According to an embodiment of the present invention, the requirement matching module comprises:

a level matching module communicatively coupled with the transaction analysis module and the character analysis module, wherein the level matching module matches to obtain the character available for assignment to the transaction according to the character requirement of the transaction and the level of the character; and

a time matching module communicatively respectively coupled with the transaction module and the character analysis module, wherein the time matching module matches to obtain the character having the available time before the processing deadline of the transaction.

According to an embodiment of the present invention, the transaction management system further comprises an assignment module communicatively coupled with the analysis module to analyze the character that can be assigned according to the analysis module to select the executor of the transaction.

According to another aspect of the present invention, the present invention further provides a transaction managing method comprising the steps of.

(A) analyzing a character requirement for at least one transaction;

(B) analyzing an available time of at least one character; and

(C) screening the character that meets the character requirements and has the available time before a processing deadline of the transaction to be at least one executor of the transaction.

According to an embodiment of the present invention, the step (A) further comprises the steps of:

determining a type of the transaction; and

dividing at least one processing stage of the transaction.

According to an embodiment of the present invention, the step (B) further comprises the steps of:

analyzing a working state of the character;

calculating an average processing time of the transactions of the character processed; and

calculating the available time of the character.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram according to a preferred embodiment of the present invention.

FIG. 2 is a schematic view of the transaction and the character according to the above preferred embodiment of the present invention.

FIG. 3 is a flow chart according to the above preferred embodiment of the present invention.

FIG. 4 is a schematic view of the state of the character according to the above preferred embodiment of the present invention.

FIG. 5 is a schematic view of the transaction waiting to be assigned and the state of the character according to the above preferred embodiment of the present invention.

FIG. 6 is a schematic view of processing transaction according to the above preferred embodiment of the present invention.

FIG. 7 is a flow chart according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The present invention provides a transaction management system which creates at least one transaction and assigns to at least one character, so the character can finish the transaction before a processing deadline. The transaction management system assigns the transaction to suitable character according to a processing cost of each character and the processing deadline of the transaction.

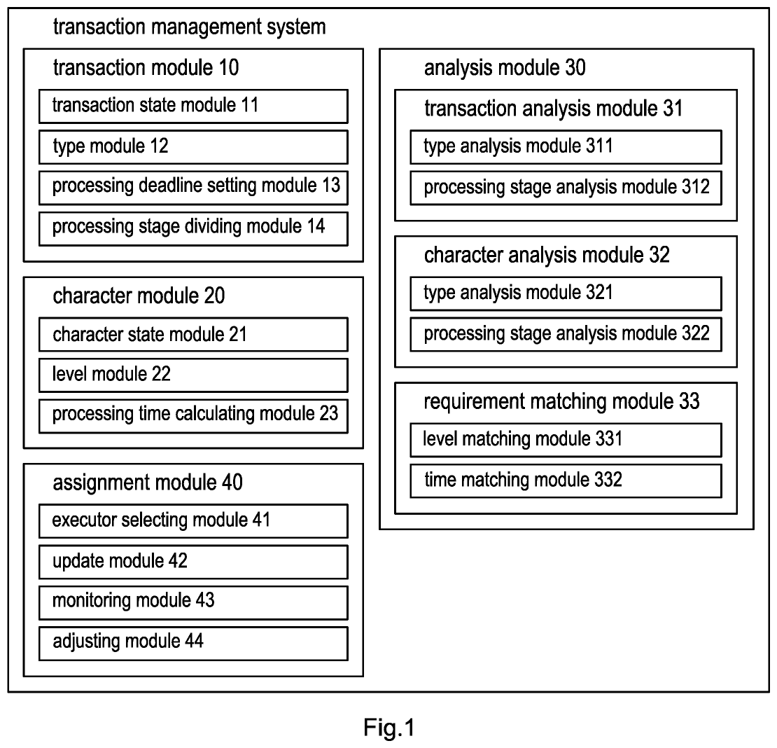

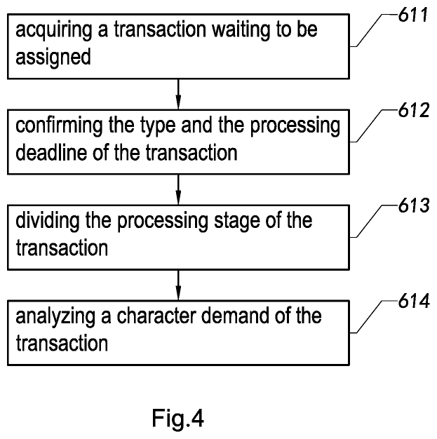

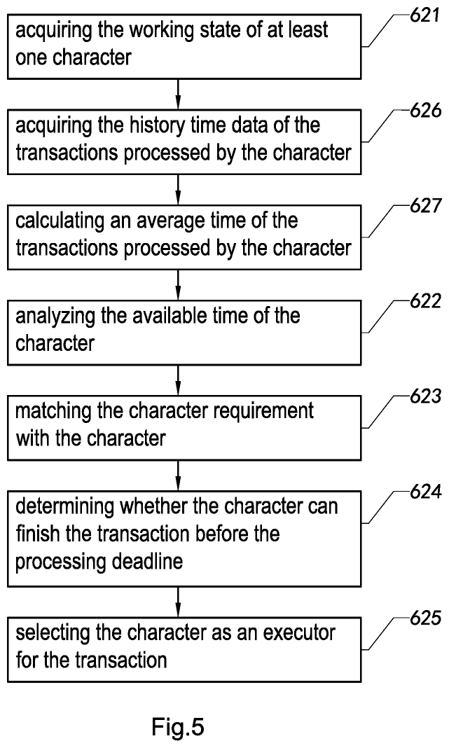

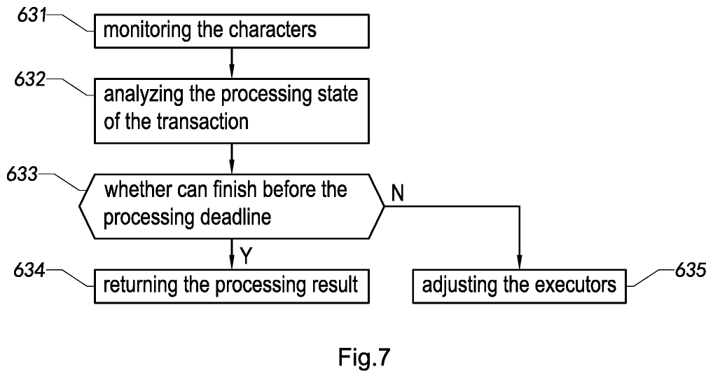

As shown in FIG. 1 to FIG. 7, illustrating an embodiment of the invention, the transaction management system creates at least one transaction 710, and the transaction is assigned to at least one character 720. The character 720 can finish the transaction 710 before a processing deadline 714. The transaction management system assigns the transaction 710 to suitable character 720 according to a processing cost of each character 720 and the processing deadline 714 of the transaction 710.

The transaction system comprising a transaction module 10 and a character module 20, wherein the transaction module 10 and the character module 20 respectively manages the transaction 710 and the character 720. The transaction management system acquires the data of the transaction 710 by the transaction management module 10 and acquires the data of character 720 by the character module 20, so as to manage the transaction 710 and the character 720.

The transaction management system further comprises an analysis module 30, wherein the analysis module 30 are communicatively connected with the transaction module 10 and the character module 20. The analysis module 30 acquires the transaction 710 to be assigned and related information of the transaction 710 from the transaction module 10 to analyze the transaction 710. The analysis module 30 generates a character requirement of the transaction 710. The analysis module 30 acquires the character 720 and the related information of the character 720 from the character module 20. The analysis module 30 analyzes the working state of the character 720. The analysis module 30 further matches the working state of the character 720 with the character requirement of the transaction 710, so as to assign the transaction 710 to suitable character 720, which is an analysis result.

The transaction management system further comprises an assignment module 40 communicatively connected with the analysis module 30. The analysis module 30 transmits the analysis result to the assignment module 40. The assignment module 40 specifies an executor of the transaction 710 based on the analysis result.

The assignment module 40 monitors the executor of the transaction 710 to ensure the processing efficiency of the transaction 710.

The transaction module 10 comprises a transaction state module 11, wherein the transaction state module 11 acquires information of the transaction 710 to create the transaction 710. The transaction state module 11 analyzes the state of the transaction 710 to determine whether the transaction has been assigned. The transaction state module 11 filters out the transactions 710 to be assigned.

The transaction state module 11 creates the transaction 710, records the information of transaction 710, analyzes the state of the transaction 710, monitors the transaction 710, updates the information of the transaction 710, and the like.

The transaction module 10 further comprises a type module 12, wherein the type module 12 classifies each of the transaction 710 managed by the transaction state module 11 to determine the type of the transaction 710. The type module 12 identifies the transaction 710 by the type.

In an application of the present invention, the transaction management system manages patent cases. The transaction state module 11 acquires three transactions 710 to be assigned. The type module 12 classifies three transactions 710 to be assigned to determine transactions are drafting Chinese invention patent, drafting Chinese utility patent and drafting Chinese design patent.

The transaction module 10 further comprises a processing deadline setting module 13 and a processing stage dividing module 14, wherein the processing deadline setting module 13 sets a processing deadline 714 of the transaction, wherein the processing stage dividing module 14 determines at least one processing stage 711 that the transaction 710 needed to be done.

The processing deadline setting module 13 is communicatively connected with the transaction state module 11 to acquire information of the transaction. When the information acquired by the transaction state module 11, the processing deadline setting module 13 sets the processing deadline 714 of the transaction 710 according to the information acquired by the transaction state module 11. The processing deadline setting module 13 is connected with the type module 12 to obtain the type of the transaction 710. The processing deadline setting module 13 sets the processing deadline 714 according to the type that the transaction 710 belongs. For example, the processing deadline setting module 13 analyze the time that this type of the transaction 710 needed according to the history data of processed transaction 710 in this type, to set the processing deadline 714 of the transaction to be assigned.

The processing stage dividing module 14 is communicatively connected with the type module 12, and acquires the type of the transaction of the transaction. The processing stage dividing module 14 divides the processing stage 711 of the transaction according to the type.

In the application of the present invention, the transaction state module 11 acquires time information of each of the transaction 710 to be assigned. The processing deadline setting module 13 according to the information of transaction 710 acquired by the transaction state module 11 sets the processing deadline 714 of the Chinese invention patent, Chinese utility patent and Chinese design patent are all November 8.

The processing stage dividing module 14 acquires the type of each of the transaction 710 to be assigned from the type module 12, and the types are Chinese invention patent, Chinese utility patent and Chinese design patent. The processing stage dividing module 14 treats each of the transaction 710 to be assigned respectively to divide the processing stage 711. Specifically, the processing stage 711 of the Chinese invention patent and the Chinese utility patent includes drafting, drawing, and reviewing. The processing stage 711 of the Chinese design patent includes drawing and reviewing.

The transaction module 10 analyzes the transaction assignment 710 to obtain the data for analysis, and the data comprises and not limited to processing stage 711 and the processing deadline 714.

The character module 20 manages the character 720. The character module 20 comprises a character state module 21 managing the character 720 and the information of the character 720. The character state module 21 creates a character 720 based on the information of the character 720. The character state module 21 records the information of character 720 and the state of the character 720.

The character state module 21 records a responsibility 721 of the character 720, The responsibility 721 is what the character 720 needs to process while processing the transaction 710.

The character state module 21 records the transactions 710 to which the character 720 is assigned, so as to know the state of the character 720. The character state module 21 to collect historical data of each of the character 720, comprising but not limited to processing the transaction history data 710 in order to know the history of the state of the character 720. The character state module 21 further records a starting time and ending time of the transaction 710 processed by the character.

The character module 20 further comprises a level module 22 connected with the character state module 21 to acquire information of the character 720. The level module 22 imparts a level 722 to character 720, and the level 722 identifies the processing capability of the character 720.

The character module 20 further comprises a processing time calculating module 23 communicatively connected with the character state module 21, and the processing time calculating module 23 acquires the historical data of the transaction 710 processed by the character 70 from the character state module 21 to calculate an average processing time 7 25 required by the character 720 to process the transaction 710.

The character state module 21 records the start time and end time of the transaction 710 and the information of the transaction 710 processed in history, including the type of the transaction 710. The processing time calculating module 23 acquires the history data of the different types of transaction 710 processed by the character 720 from the character state module 21, to calculate the average processing time 725 of each of type of the transaction 710 processed by each the character 720.

In an application of the present invention, the character module 20 manages a plurality of the characters 720. Specifically, the character state module 21 records that the character 720 comprises A1, A2, A3, and B1, B2, The character state module 21 further records the responsibilities 721 of the characters 720. As the characters 720, the responsibilities of A1, A2, and A3 are drafting engineers, and B1 and B2 are drawing engineers.

The level module 22 assigns the level 722 corresponding to each of the characters 720 to reflect the processing capabilities of the level 722. The level module 22 assigns to the character 720 that the levels 722 of A1, A2, and A3 respectively are primary, advance, and, senior, and the levels 722 of B1 and B2 respectively are primary and advance.

The analysis module 30 acquires the transaction 710 to be assigned from the transaction module 10 to analyze requirement of the transaction 710. The analysis module 30 acquires the characters 720 from the character module 20, to analyze whether the transaction 710 can be assigned to the character 720.

The analysis module 30 comprises a transaction analysis module 31 communicatively connected with the transaction module 10 to acquire the transaction 710 from the transaction module 10. The transaction analysis module 710 analyzes the transaction 710 to obtain at least one character requirement 712 of the transaction 710.

Specifically, the analysis transaction module 31 comprises a type analysis module 311 analyzing character requirement 712 of the transaction 710 according to the type of the transaction 710. The type analysis module 311 is communicatively coupled with the type module 12 of the transaction module 10 to obtain the type of the transaction 710.

The type analysis module 311, based on the type of the transaction 710 to be assigned, analyzes the character 720 of transaction 710. In the above application of the present invention, the transaction 710 to be assigned managed by the transaction module 10 is one Chinese invention patent, one Chinese utility patent, and one Chinese design patent, and the analysis module 30 needs to analyze the transaction 710 to be assigned which is the drafting of the Chinese invention patent, the Chinese utility patent and the Chinese design patent, and the type analysis module 311 analyzes that the types of the transaction 710 are Chinese invention patent, Chinese utility patent, and The Chinese design patent, and the type analysis module 311 further analyzes the character requirement 712 of the Chinese invention patent as one drafting engineer and one drafting engineer, and the type analysis module 311 analyzes and processes the character requirement 712 of the Chinese utility patent as one drafting engineer and one drafting engineer. The type analysis module 311 analyzes the character requirements 712 of the Chinese design patent as one drafting engineer and one drafting engineer.

The transaction analysis module 31 further comprises a processing stage analysis module 312 analyzing the character requirements 712 according to each of the processing stage 711 of the transaction 710. In other words, the processing stage analysis module 312 analyzes the responsibilities 721 that the character 720 of each of the processing stages 711 of the transaction 710 can handle. The processing stage analysis module 312 analyzes the character requirements 712 of each of the processing stage 711 of the transaction 710.

The processing stage analysis module 312 acquires each of the processing stages 711 of the transaction 710 from the transaction module 10. The processing stage module 312 obtains the transaction 710 to be assigned and the corresponding processing stage 711. Specifically, in the transaction 710 to be assigned, the processing stages 711 of the drafting Chinese invention patent are respectively drafting, drawing, and reviewing, and the processing stages 711 of the drafting Chinese utility patent are respectively drafting, drawing, and reviewing. The processing stages 711 of the design patent are respectively drawing and reviewing. The processing stage analysis module 312 needs to analyze the character requirements 712 of each of the processing stages 711 of the Chinese invention patent, the Chinese utility patent, and the Chinese design patent.

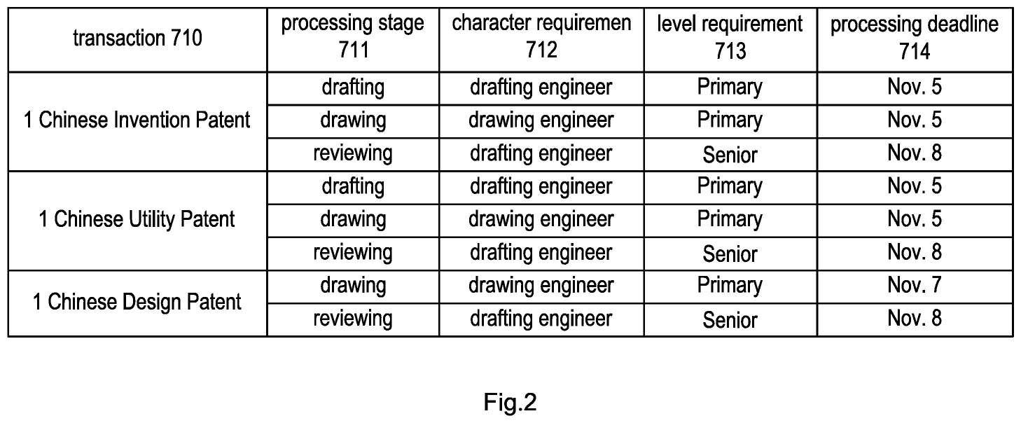

FIG. 2 shows the various data of information of the transaction 710 to be assigned, comprising but not limited to the processing stages 711 and the character requirements 712. The analysis result of the processing stage analysis module 312 is each of the processing stages 711 and the character requirement 712, wherein the character requirements 712 of the drafting stage, the drawing stage and the reviewing stage of the Chinese invention patent or Chinese utility patent are corresponding drafting engineers, drawing engineers, and reviewing engineers, and the character requirements 712 of the drawing stage and the reviewing stage of Chinese design patent are drawing engineers and reviewing engineers.

The transaction analysis module 31 analyzes the character requirements 712 according the type and the processing stage 711, so as to determine the responsibilities 721 of the characters 720 of each of the processing stage 711 of the transaction 710 according to the character requirements 712.

The transaction analysis module 31 further analyzes the processing capabilities of the character 720 required to process the transaction 710, which is the level 722 that the character 720 needs to have, so as to generate a level requirement 713.

The type analysis module 311 analyzes the level requirements 713 by the types of the transaction 710. The processing stage analysis module 312 further analyzes the level requirements 713 of each of the processing stages 711 of the transaction 710.

The processing stage dividing module 14 divides the processing stages 711 according to the specific content that the transaction 710 needs to be processed. Each of the processing stage 711 has a specific content that each needs to be processed.

The processing stage analysis module 312 analyzes the level requirements 713 according to the specific content that each of the processing stages 711 needs to be processed. In other words, the processing stage analysis module 312 analyzes the processing capabilities that the character 720 of each of the processing stages 711 needs to have.

The type module 12 identifies the type to which each of the transactions 710 belongs. The type identifies the processing requirements of the transaction 710. For example, the type module 12 identifies the transaction 710 is an A class transaction, which is highly required and difficult transaction. And the type module 12 indicates that transaction 709 is the A class transaction, indicating that the transaction 710 is complicated. When the transaction analysis module 31 analyzes the transaction 710 identified by the type module 12 as A class transaction, the type analysis module 311 analyzes that the type of the transaction 710 is A class, and the processing requirement is high. The type analysis module 311 analyzes that the character 720 that processes the transaction 710 needs to have a stronger processing capability, which is the level 722 of the character 720 is high.

In other words, the type module 12 identifies that the type of the transaction 710 can indicate the processing difficulty of the transaction 710, and the type analysis module 311 determines the processing difficulty of the transaction 710 based on the type of the transaction 710 to be assigned to determine the level requirement 713 of the character 720 that processes the transaction 710.

Specifically, in the transaction 710 to be assigned, the type module 12 indicates that the types to which the transaction 710 to be assigned belongs are all C class. The C class indicates that the processing of the transaction 710 is difficult. The type analysis module 311 analyzes the level requirement 713 of the transaction 710 to be assigned according to the type of C class is the lowest class as the level 722 is primary. In other words, the character 720 having the level 722 is primary level has the ability to process the transaction 710 to be assigned.

The type analysis module 311 analyzes the level requirements 713 of the transaction 710 based on the type to which the transaction 710 belongs. The processing stage analysis module 312 analyzes the level requirements 713 according to the processing stages 711 of each of the transactions 710. The drafting processing stages 711 of the Chinese invention patent are drafting, drawing and reviewing. The processing stages 711 of the drafting Chinese utility patent are drafting, drawing and reviewing. The processing stages 711 of the Chinese design patent are drawing and reviewing.

The processing difficulty of each of the processing stages 711 of the transaction 710 to be assigned increases as the processing stage 711 advances. According to the type analysis module 311, the level 722 of the character 720 that processes the transaction 710 to be assigned is lowest, and the level requirements 713 of the transaction 710 to be assigned specifically are: the level requirements 713 of each processing stage 711 of the drafting of the Chinese invention patent have primary, advance and senior; the level requirements 713 of each processing stage 711 of the drafting of the Chinese utility patent have primary, advance and senior; the level requirements 713 of each processing stage 711 of the drafting of the Chinese design patent have primary and senior.

In the above application of the present invention, the type analysis module 311 analyzes the level requirement 713 of the transaction 710 as a whole by the type to which the transaction 710 to be assigned belongs, and the level requirement 713 reflects the lowest level 722 required by the character 720 of the transaction 710. The processing stage analysis module 312 further analyzes the level requirements 713 according to each of the processing stages 711 of the transaction 710 to be assigned, wherein the processing stage analysis module 312 further determines the level requirement 713 of each of the processing stages 711 according to the level requirement 713 of each of the processing stages 711.

The transaction analysis module 31 determines processing capability required by the character 720 of the transaction 710 according to the specific content of the transaction 710 to be assigned to generate the level requirements 713. The transactional analysis module 31 analyzes the character requirements 712 and the level requirements 713 of the transaction 710 to be assigned to determine the responsibilities 721 of the characters 720 of the transaction 710 to be assigned.

The analysis module 30 further comprises a character analysis module 32 communicatively coupled with the character module 20 to obtain information of each of the character 720 and the character 720. The character analysis module 32 analyzes the character 720 to determine a working state 723 and an available time 724 of the character 720.

The character analyzing module 32 comprises a working state analysis module 321 communicatively coupled with the character module 20, to obtain information of each of the character 720 and the character 720. The character state module 21 records the transactions 710 that each of the characters 720 has been assigned and information of the transactions 710. The analysis module 321 analyzes the working state 723 of each of the character 720 according to each of the working state 723 recorded in the character state module 21.

The working state analysis module 321 analyzes each of the transaction 710 had been assigned to the character 720, and analyzes the transaction 710 currently being processed or to be processed of each of the character 720.

It is worth to mention that the character state module 21 further records information of the transaction 710 while recording the transaction 710 had been designated to the character 720.

The character analysis module 32 further comprises an available time analysis module 322 communicatively coupled with the working state analysis module 321, for acquiring the working state 723 of each of the characters 720. The character analysis module 32 analyzes determines the transaction 710 that the character 720 is currently assigned according to the working state analysis module 321 and analyzes the available time 724 of the character 720 based on the efficiency of the character 720 processing the transaction 710.

The character module 20 manages the historical data of the character 720 while managing the character 720. The character state module 21 records the start time and end time of the character 720 processing each of the transactions. The available time analysis module 322 obtains history data of the transaction 710 processed by the character 720 from the character state module 21. In other words, the start time and end time, to calculate an average processing time 725 of the character 720 processing the transaction 710.

In other words, the available time analysis module 322 analyzes the average processing time 725 processing the transaction 710 of the character 720 according to the historical data of the character 720 processing the transaction 710.

The available time analysis module 322 is communicatively coupled with the working state analysis module 321 to acquire the working state 723 of the character 720 to determine the transaction 710 currently assigned to the character 720.

The available time analysis module 322 analyzes the available time 724 of the character 720 based on the working state 723 and the average processing time 725.

It is worth to mention that the processing deadlines 714 of the transactions 710 that the character 720 is currently assigned are not the same. There is a character 720 that the processing deadline 714 of the transaction 710 had been assigned is after the processing deadline 714 of the current transaction 710 to be assigned. Thus, in one example of the present invention, the available time analysis module 322 filters from the working state 723 that the transaction 710 had been assigned and having the processing deadline 714 before the processing deadline 714 of the transaction 710 to be assigned, and analyzes the available time 724 in combination with the average processing time 725 of the character 720. In another example of the present invention, the available time analysis module 322 combines the average processing time 725 to analyze the available time 724 of the character 720 according to the working state 723 of the transaction 710 to which the current character 720 has been assigned.

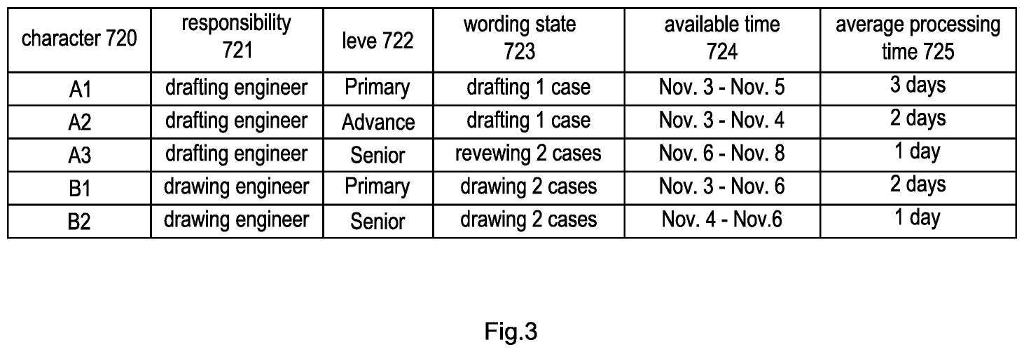

In the application of the present invention, the character analysis module 32 use the available time 724 of A1, A2, A3 and B1, B2 for analysis, as shown in FIG. 3, to obtain the available time 724 of each of the character 720.

The analysis module 30 further comprises a requirement matching module 33 communicatively connected with the transaction analysis module 31 to acquire the character requirements 712 and the level requirements 713 of the transaction 710 to be assigned. The requirement matching module 33 is communicatively connected with the character analysis module 31 to acquire information of the character 720 comprising the character 720 of the responsibilities 721, the level 722 and the available time 724.

The requirement matching module 33 matches the character requirement 712 and the level requirement 713 of the transaction 710 to be assigned with the information of the character 720 to obtain the character 720 that meet the character requirement 712 and the level requirement 713 of the transaction 710.

The requirement matching module 33 comprises a level matching module 331 communicatively connected with the transaction module 31 to acquire the character requirement 712 and the level requirement 713 of the transaction 710 to determine the responsibility 721 and the level 722 of the character 720 that the transaction 710 need. The level matching module 331 filters out the character 720 that matches the character requirement 712 and the level requirement 722 from the characters 720.

The requirement matching module 33 further comprises a time matching module 332 communicatively connected with the character analysis module 32 to acquire the available time 724 of the character 720.

The time matching module 332 is communicatively coupled with the transaction module 10 to obtain the processing deadline 714 of the transaction 710 from the transaction module 10.

The time matching module 332 is communicatively coupled with the transaction analysis module 31 to obtain information of the transaction 710 to be assigned, and the time matching module 332 obtains the processing deadline 714 of the transaction 710 from information of the transaction 710.

The time matching module 332 matches the processing deadline 714 with the available time 724 of the character 720 to find the character 720 having available time 724 before the processing deadline 714.

The requirement matching module 33 filters out the character 720 that meets the character requirement 712 and the level requirement 713 of the transaction 710 to be assigned, and has the available time 724 before the processing deadline 714, and the character 720 is capable to be assigned.

The analysis module 30 filters out the characters 720 that are available for assignment to meet the requirements of the transaction 710 in accordance with the analysis of the transaction 710 to be assigned and the character 720.

In the above application of the present invention, the character matching module 33 matches the character requirement 712, the level requirement 713, and the processing deadline 714, and A1, A2, A3, and B1, B2 are all available for assignment. The character 720 of each of the processing stages 711 of the transaction 710 to be assigned is further determined by the assignment module 40.

The assignment module 40 acquires the character 720 available for assignment from the analysis module 30. The assignment module 40 specifies at least an executor of the transaction 710 from the characters 720 that are available for assignment.

The assignment module 40 comprises an executor selecting module 41 selecting the executor of the transaction 710 to be assigned from the characters 720 that are available for assignment.

The executor selecting module 41 selects the executors for each of the processing stages 711. The executor selecting module 41 determines the processing stage 711 of the transaction 710 processing sequence, and filters the character 720 that is sequentially performed each of the processing stages 711 as the executor based on the character 720 that is available for assignment of each of the processing stages 711.

In other words, the executor selected by the executor selecting module 41 for each of the processing stages 711 can cooperatively process the transaction 710, so that the each of the processing stages 711 of the transaction 710 is in the processing order to be finished before the processing deadline 714.

In the above application of the present invention, the drafting of the processing stage 711 and drawing of the processing stage 711 of the Chinese invention patent transaction can be performed together.

The reviewing of the processing stage 711 needs to be waiting after the drafting and drawing, so that the executors of the drafting and drawing needs to finish before a certain period to ensure that the reviewing can be completed before the processing deadline 714.

In an example of the present invention, after the processing stage dividing module 14 divides each of the processing stages 711, the processing deadline setting module 13 sets the processing deadline 714 of each of the processing stages 711. The processing deadlines 714 of Chinese invention patent, Chinese utility patent and Chinese design patent are arranged by the processing deadline setting module 13 are November 8. Furthermore, the processing deadline setting module 13 sets processing deadlines 714 of drafting stage and drawing stage of the Chinese invention patent and Chinese utility patent are November 5, and the processing deadlines 714 of reviewing stage is November 8. And processing deadline 714 of drafting stage Chinese design patent is November 7, and the processing deadline 714 of reviewing stage is November 8.

When the requirement matching module 33 determines the character 720 that can be assigned for each of the processing stages 711, the available time 724 of the character 720 matches the processing stage 711 and the processing deadline 714, and the level requirement 713 and the character requirement 712 are filtered to find the character having the available time 724 before the processing deadline 714 of the processing stage 711. The character 720 is the one that is assignable by the assignment module 40.

The time matching module 332 matches the assignable characters 720 according to the processing deadline 714 of each of the processing stages 711 and the available time 724 of the character 720.

The executor selecting module 41 selects the executor for each of the processing stages 711 of each of the transactions 710. The executor meets the character requirement 712 and the level requirement 713 of the processing stage 711, and having available time 724 is before the processing deadline 714.

It is worth to mention that each of the characters 720 can be assigned to the executor of a plurality of the processing stages 711 of the same transaction 710, and can also be assigned to the different executors of the transaction 710.

When the assignable characters 720 of each of the processing stages 711 are several person, and the characters 720 are for several process stages 711 of the transaction 710. In the above application of the present invention, the character 720 that can be assigned in the drafting stage of the Chinese invention patent comprises A1 and A2, and both A1 and A2 are the characters 720 that can be assigned as the drafting stage of the Chinese utility patent. The executor selecting module 41 calculates the capabilities of the transaction 710 that the character 720 can process in the available time 724 before the processing deadline 714. A1 and A2 can process one of the transactions 710 within the available time 724 and before the processing deadline 714. Both A2 and A2 can only be assigned one of the transactions 710. A1 and A2 are respectively assigned to the executor of the drafting phase of the Chinese invention patent and the Chinese utility patent.

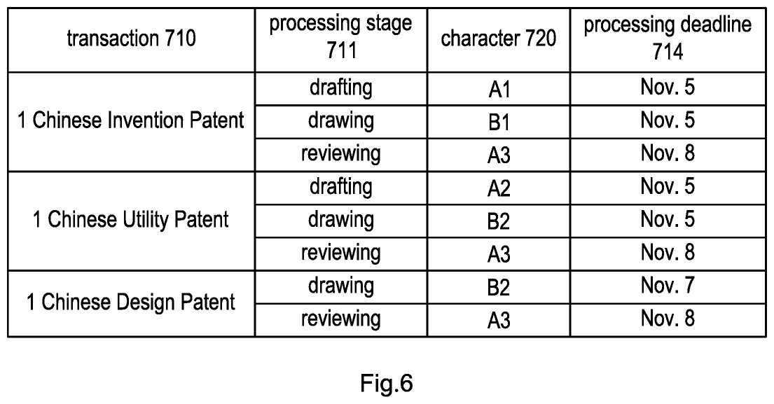

Similarly, the executor selecting module 41 selects the executor for each of the processing stages 711 of the Chinese invention patent, the Chinese utility patent, and the Chinese design patent. FIG. 6 shows the result of the transaction 710 being selected by the executor selecting module 41.

The assignment module 40 further comprises an update module 42 communicatively connected with the executor selecting module 41. The update module 42 acquires the executor of each of the processing stages 711 of each of the transactions 710 from the executor selecting module 41, and feeds back information of the assigned executors to the transaction module 10. The transaction module 10 updates the state of the managed transaction 710, and the transaction 710 to be assigned is updated to the assigned transaction.

The update module 42 feeds back the character 720 selected as the executor of the transaction 710 to the character module 20 such that the character module 20 updates the state of the managed character 720.

The state change is returned to the transaction module 10 and the character module 20 by the update module 42 in real time, so that the transaction module 10 and the character module 20 update the state information of the transaction 710 and the character 720 in real time.

The present invention further provides a transaction managing method, and the transaction managing method comprises the following steps:

611: acquiring at least one transaction to be assigned;

612: determining a type and a processing deadline of the transaction;

613: dividing processing stages of the transaction;

614: analyzing a character requirement of the transaction.

In the step 611, the transaction 710 to be assigned is acquired by the transaction state module 11. In the step 612, the type of the transaction 710 is determined by the type module 12, and the processing deadline 714 is set by the processing deadline setting module 13. In the step 613, the processing stages 711 of the transaction 710 are divided by the processing stage dividing module 14. In the step 614, the character requirements 712 of the transaction is analyzed by the transaction analysis module 31. In the step 614, the character requirement 722 of the transaction 710 is further analyzed by the transaction analysis module 31.

The transaction managing method further comprises the following steps:

621: acquiring a working state of at least one character;

622: analyzing the available time of the character;

623: matching the character requirement and the character of the transaction;

624: determining whether the character can finish the transaction before the processing deadline;

625: selecting the character as an executor of the transaction.

In step 621, the current transaction 710 had been assigned of the character 720 is acquired form the character module 10 by the character analysis module 32 to analyze the working state 723 of the character 720.

In the step 622, the available time 724 of the character 720 is analyzed by the working state 723 of the character 720.

In the step 623, the character requirement 712 of the transaction 710 and the character 720 are matched by the requirement matching module 33. In the step 623, the level requirement 713 of the transaction 710 and the character 720 are further matched by the requirement matching module 33.

In the step 624, it is determined by the requirement matching module 33 whether the available time 724 of the character 720 is before the processing deadline 714 of the transaction 710.

In the step 625, the executor of the transaction 710 is selected by the executor selecting module 41.

Between the step 621 and the step 622, the following steps are further comprised:

626: obtaining historical time data of the transaction processed by the character;

627: calculating an average processing time of the character to process the transaction.

In step 626, the historical time data of the transaction 710 processed by the character 720 by the character state module 21. And in the step 627, the average processing time of the transaction 710 processed by the character 720 is calculated by the character analysis module 32 to generate the average processing time 725 of the character 720.

The assignment module 40 further comprises a monitoring module 43 and an adjusting module 44. The transaction managing method further comprises the following steps:

631: monitoring the character;

632: analyzing the processing of the transaction;

633: whether finishing before the processing deadline;

634: return processing result;

635: adjusting the executor.

The monitoring module 43 is communicatively connected with the transaction module 10 and the character module 20 to monitor the processing state of the transaction 710 and the situation of the character 720 to analyze whether the transaction 710 can be finished before the processing deadline 714. The adjusting module 44 is communicatively connected with the monitoring module 43. When the monitoring module 43 analyzed that the transaction 710 can not be finished before the processing deadline 714, the adjusting module 44 send an executor adjusting order. The adjusting module 44 is communicatively connected with the analysis module 30 to send the executor adjusting order to the analysis module 30. The analysis module 30 analyzes currently processing stages of the transaction of the executor needed to be adjusted and the working state 723 and the available time 714 of the character 720 again, and the executor selecting module 41 selects the executor again to ensure the transaction 710 can be finished before the processing deadline 714.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention comprises all modifications encompassed within the spirit and scope of the following claims.

What is claimed is:

1. A transaction management system, comprising:
an analysis module, analyzing a character requirement and a processing deadline of at least one transaction to be assigned, wherein the analysis module analyzes a working state of at least one character to obtain an available time; and
an assignment module, communicatively connected with the analysis module to assign the character having available time before the processing deadline and meeting the character requirement to be at least one executor of the transaction.

2. The transaction management system as recited in claim 1, further comprising a transaction module acquiring the information of the transaction to create the transaction and recording the state of the transaction, wherein the analysis module is communicatively connected with the transaction module to acquire information from the transaction module.

3. The transaction management system as recited in claim 2, wherein the transaction module comprises:
an transaction state module creating the transaction, wherein the transaction state module records the information of the transaction, wherein the transaction state module records contents needed to be processed; and
an type module communicatively connected with the transaction state module to acquire the transaction and information of the transaction, wherein the type module determines a type of the transaction according to the contents needed to be processed.

4. The transaction management system as recited in claim 2, wherein the transaction module comprises:
an processing deadline setting module communicatively connected with the transaction state module to acquire the information of the transaction and the transaction, wherein the processing deadline sets a processing deadline for the transaction; and
a processing stage dividing module communicatively connected with the transaction state module to acquire the information of the transaction and the transaction, wherein the processing stage dividing module divides at least one processing stage of the transaction according to the contents needed to be processed.

5. The transaction management system as recited in claim 4, wherein the processing stage dividing module is communicatively connected with the type module to acquire the type that the transaction belongs, wherein the processing stage dividing module divides the processing stages of the transaction according to the type of the transaction.

6. The transaction management system as recited in claim 4, wherein the processing deadline setting module is communicatively connected with the processing stage dividing module to acquire the processing stages of the transaction, wherein the processing deadline setting module sets the processing deadline for each of the processing stages of the transaction.

7. The transaction management system as recited in claim 1, further comprising a character module managing the characters, wherein the analysis module is communicatively connected with the character module to acquire the character for analysis.

8. The transaction management system as recited in claim 7, wherein the character module comprises:
a character state module creating the character to record information of the character; and
a level module communicatively connected with the character state module to acquire the character, wherein the type module gives the character a level.

9. The transaction management system as recited in claim 8, wherein the character module further comprises a processing time calculating module communicatively connected with the character state module, wherein the character state module records history data of the transaction processed by the character, wherein the processing time calculating module calculates an average processing time of the character processed the transactions.

10. The transaction management system as recited in claim 1, wherein the analysis module comprises a transaction analysis module and a character analysis module, wherein the transaction analysis module is communicatively connected with the transaction module to analyze the transaction, wherein the character analysis module is communicatively connected with the character module to analyze the character.

11. The transaction management system as recited in claim 10, wherein the transaction analysis module comprises:
a type analysis module communicatively connected with the transaction module to acquire the type of the transaction, wherein the type analysis module analyzes the character requirements of the transaction according to the type of the transaction; and
a processing stage analysis module communicatively connected with the transaction module to acquire the process stage of the transaction, wherein the processing stage analyzes the character requirement of the processing stage of the transaction.

12. The transaction management system as recited in claim 11, wherein the type analysis module further analyzes processing difficulty of the transaction according to the type of the transaction to generate a level requirement, wherein the processing stage analysis module further generates the level requirement of each of the processing stages according to the processing difficulty of each of the processing stages of the transaction.

13. The transaction management system as recited in claim 12, wherein the character analysis module comprises:
a working state analysis module communicatively connected with the character module to acquire the transaction assigned to the character to analyze the working state of the character; and
an available time analysis module communicatively connected with the working state analysis module to acquire the working state of the character, wherein the available time analysis module is communicatively connected with the character module to acquire the average processing time of the transactions processed by the character from the processing time calculating module, wherein the available time analysis time module calculates the available time of the character according to the working state and average processing time of the character.

14. The transaction management system as recited in claim 13, wherein the analysis module comprises a requirement matching module respectively communicatively connected with the transaction analysis module and the character analysis module to respectively acquire the character requirement and the available time of the character, wherein the requirement matching module matches to obtain the character that is capable of assigning to the transaction.

15. The transaction management system as recited in claim 14, wherein the requirement matching module comprises:
a level matching module communicatively connected with the transaction analysis module and the character analysis module, wherein the level matching module matches to obtain the character to be assigned according to the level requirement of the transaction and the level of the character; and
a time matching module respectively communicatively connected with the transaction module and the character analysis module, wherein the time matching module obtains the character having available time before the processing deadline of the transaction.

16. The transaction management system as recited in claim 15, further comprising an assignment module communicatively connected with the analysis module to select the executer for the transaction according to the character analyzed by the analysis module.

17. A transaction managing method, comprising the steps of:
(A) analyzing a character requirement of at least one transaction;
(B) analyzing an available time of at least one character; and
(C) filtering the character met the character requirement and having the available time before a processing deadline to be at least one executer.

18. The transaction managing method as recited in claim 17, before the step (A), further comprising steps of:
determining a type of the transaction; and
dividing at least one processing stage of the transaction.

19. The transaction managing method as recited in claim 17, before the step (B), further comprising steps of:
analyzing a working state of the character;
calculating an average processing time of the transactions processed by the character; and
calculating the available time of the character.
